(19) United States
(12) Patent Application Publication
(10) Pub. No.: US 2006/0195557 A1
(43) Pub. Date: Aug. 31, 2006

(54) Configuration of digital content communication systems

(75) Inventors: Donald Dew, Ajax (CA); M. Michael Serbinis, Toronto (CA); Robert Zuber, San Francisco, CA (US)

Correspondence Address: THELEN REID & PRIEST, LLP, P. O. BOX 640640, SAN JOSE, CA, 95164-0640, US

(73) Assignee: Critical Path, Inc., a California Corporation

(21) Appl. No.: 11/351,870

(22) Filed: Feb. 10, 2006

Related U.S. Application Data
(60) Provisional application No. 60/652,261, filed on Feb. 11, 2005.

(51) Int. Cl. G06F 15/177

(52) U.S. Cl. 709/220

(57) ABSTRACT

A method and system for ascertaining configuration information for a digital content communication system to access a digital content account is disclosed. For one embodiment of the invention, one or more candidate configurations are determined using configuration information provided by the user in conjunction with known configuration parameters applicable to such systems. For one embodiment of the invention configuration information is ascertained and a digital content communication system configured using configuration information provided by the user in conjunction with configuration information stored by the system. Additionally, or alternatively, the digital content communication system may use configuration information provided by the user to dynamically obtain additional required configuration information. For such embodiments, the information provided by the user may be information that is readily available to the user and may be input to the digital content communication system via a mobile device.

### CROSS-REFERENCE TO RELATED APPLICATION

This application is a non-provisional application claiming priority to provisional application Ser. No. 60/652,261, filed on Feb. 11, 2005, entitled “Message Router and Platform for Routing E-mail Between External E-mail Systems and Simple Hand-held Devices,” which is herein incorporated by reference in its entirety.

### FIELD OF THE INVENTION

Embodiments of the invention relate generally to the field of digital content communication systems and more specifically to the configuration of digital content communication systems.

### BACKGROUND OF THE INVENTION

Typical mobile messaging systems allow a user to receive digital content on a mobile communications device (mobile device). The digital content may include e-mail, news feeds (e.g., RSS news feeds), blogs, audio and video clips and multimedia for example, while mobile devices may include hand-held devices such as personal digital assistants (PDAs) and cellular phones or wireless devices having messaging functionality.

Such systems often allow the user to have digital content that is stored in one or more locations forwarded to the mobile device. For example, a user may maintain several external e-mail accounts and have the e-mail messages that get delivered to all of those accounts subsequently delivered to the mobile device.

In order to have digital content from an external digital content source forwarded, the user provides specific parameters about the external digital content source. For example, to have e-mail messages forwarded from an external e-mail account, the user specifies the host name of the e-mail server, the particular transmission protocol (e.g., POP3, IMAP, etc.), incoming and outgoing servers, authentication, and the port addresses for the external e-mail account. This information allows the digital content forwarding system to access the stored digital content for forwarding as directed by the user. For example, the user may direct the digital content forwarding system to forward the e-mail messages received at some or all of the user's external e-mail accounts to a mobile device.

Typically, a user may configure an account (e.g., an e-mail account) by obtaining this information from an account service provider which may be, for example, an Internet service provider (ISP). The user then inputs the information to an application via a personal computer. To have digital content forwarded to a mobile device, the user typically obtains the information from the account service provider and provides it to the mobile service provider. The information may be provided via the Internet by accessing a website of the mobile service provider (e.g., from a personal computer).

A disadvantage of current methods of configuring a digital content communication system to forward digital content is that the user must know, or obtain, the configuration information. This is not information that the average user retains. Such methods become even more problematic in regard to forwarding digital content to mobile devices. This is because mobile device users tend to desire to add and delete the accounts from which digital content is forwarded to their mobile devices on a much more frequent basis. For example, typical mobile service providers charge the user based upon the amount of digital content that is forwarded to the mobile device, therefore a user may wish to have digital content from specific accounts forwarded for specific times. For example, a user may wish to have e-mail messages from an employment e-mail account forwarded to a mobile device only when the user's access to such an account is limited (e.g., traveling). At such time as the user regains regular access to the account the user may wish to discontinue having e-mail messages from that account forwarded to the mobile device.

Additionally, the user may often wish to have a particular account added to the accounts from which digital content will be forwarded at a time at which access to the account service provider or access to the mobile service provider's website is not possible. In such cases it would be beneficial for the user to be able to add an account for digital content forwarding via the mobile device.

The burden of either obtaining or remembering the configuration information is often enough to dissuade the user from having digital content communicated (e.g., forwarded) as desired.

### SUMMARY OF THE INVENTION

In accordance with one embodiment of the invention a request is received from a user to configure a digital content communication system to communicate stored digital content. The request contains information related to a configuration used to configure the digital content communication system to locate and access the stored digital content. One or more candidate configurations is then determined based upon the related information. The digital content communication system then attempts to locate and access the stored digital content using one of the candidate configurations. If the stored digital content cannot be located and accessed using the candidate configuration, a successive attempt is made to locate and access the stored digital content using another of the candidate configurations.

Other features and advantages of embodiments of the present invention will be apparent from the accompanying drawings, and from the detailed description, that follows below.

### BRIEF DESCRIPTION OF THE DRAWINGS

The invention may be best understood by referring to the following description and accompanying drawings that are used to illustrate embodiments of the invention. In the drawings:

FIG. 1 illustrates a system in which a digital content communication system is configured in accordance with one embodiment of the invention;

FIG. 2 illustrates a process in which a digital content communication system is configured to locate and access stored digital content in accordance with one embodiment of the present invention;

FIG. 3 illustrates a process in which a DCC system is configured to access and forward e-mail messages from an external e-mail account in accordance with one embodiment of the invention; and

FIG. 4 illustrates a functional block diagram of a digital processing system in accordance with one embodiment of the invention.

### DETAILED DESCRIPTION

In accordance with one embodiment of the invention a method for ascertaining configuration information for a digital content communication system to access a digital content account is disclosed. For one embodiment of the invention, one or more possible configurations (candidate configurations) are determined using configuration information provided by the user in conjunction with known configuration parameters applicable to such systems. For one embodiment of the invention, configuration information is ascertained and a digital content communication system configured using configuration information provided by the user in conjunction with configuration information stored by the system. Additionally, or alternatively, the digital content communication system may use configuration information provided by the user to dynamically obtain additional required configuration information. For such embodiments, the information provided by the user may be information that is readily available to the user and may be input to the digital content communication system via a mobile device.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

Embodiments of the invention are applicable in a variety of settings in which digital content communication systems are configured.

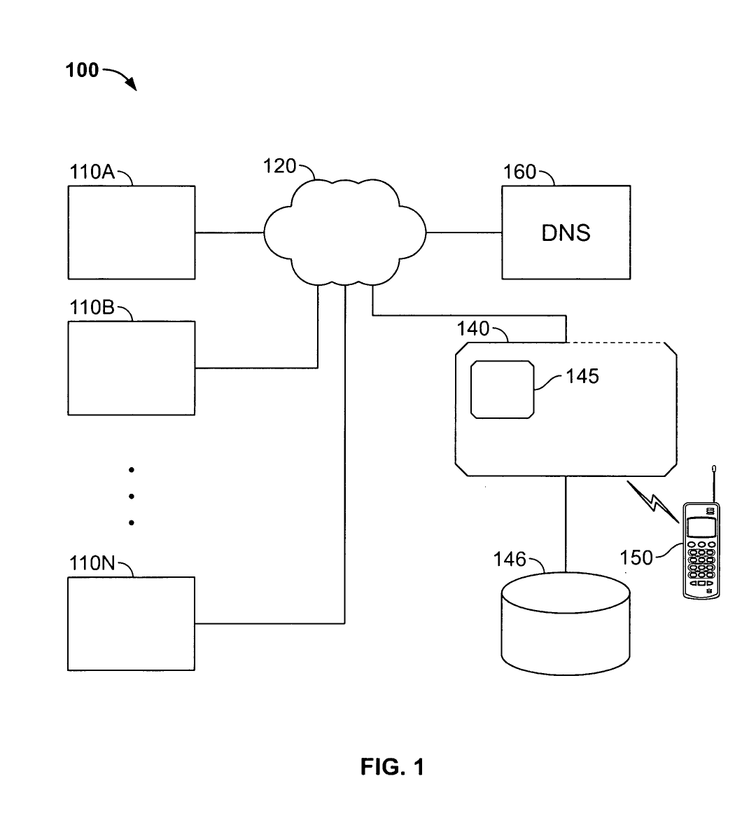

FIG. 1 illustrates a system in which a digital content communication system is configured in accordance with one embodiment of the invention. System 100, shown in FIG. 1, includes a number of digital content storage devices, shown for example as digital processing systems (DPSs) 110A-110N. The DPSs 110A-110N may be network servers (e.g., mail servers), or other types of servers storing and providing digital content. The DPSs 110A-110N are configured to store and communicate a plurality of various types of digital content which may include e-mails, news feeds, -blogs, audio and video clips and multimedia, for example, as well as documents such as web pages, content stored on web pages, including, text, graphics, and audio and video content. For example, the stored digital content may be audio/video files, such as programs with moving images and sound. The DPSs 110A-110N store digital content for a user which may have been communicated from any of a variety of sources.

The stored digital content may be communicated between the DPSs through any type of communications network through which a plurality of different devices may communicate such as, for example, but not limited to, the Internet, a wide area network (WAN) not shown, a local area network (LAN), an intranet, or the like. For example, as shown in FIG. 1, the DPSs are interconnected one to another through Internet 120 which is a network of networks having a method of communicating that is well known to those skilled in the art.

The user may wish to have some portion of the digital content stored on DPSs 110A-110N communicated in a specific manner, for example, the user may wish to have such digital content forwarded to the user's mobile device 150. The digital content communication (DCC) system 140 is connected via Internet 120 to the DPSs 110A-110N storing the digital content. The DCC system 140, which also has digital processing capabilities, has, in accordance with one embodiment of the invention, an account configuration application 145 installed thereon. Application 145 provides account configuration functionality. The DCC system has a data base, shown for example as database 146, that stores account configuration information.

The user's mobile device 150, which also has digital processing capability, is connected to the DCC system 140. The DCC system 140 may also be connected to a domain name system (DNS) server 160. The DNS server 160 is a DPS that maintains a database of digital content host systems (e.g., servers) and their corresponding IP addresses.

The communication links 102 coupling the DPSs, the DCC system, the DNS server and the mobile device need not be direct links, but may be indirect links, including but not limited to, broadcasted wireless signals, network communications or the like.

In accordance with one embodiment of the invention the user provides the application 145 configuration information regarding stored digital content that the user desires to have communicated in a specific way. In accordance with one embodiment of the invention, the configuration information, which may be provided by the user via the mobile device 150, is readily available to the user, but is not sufficient to completely define the source of the digital content or to access the digital content for communication. The application 145 uses the information provided by the user in conjunction with a set of rules that apply generally to the communication of digital content and define how a majority of accounts are configured.

In accordance with one embodiment of the invention, the application 145 may alternatively, or additionally, correlate the information provided by the user with previously determined configuration information stored in database 146.

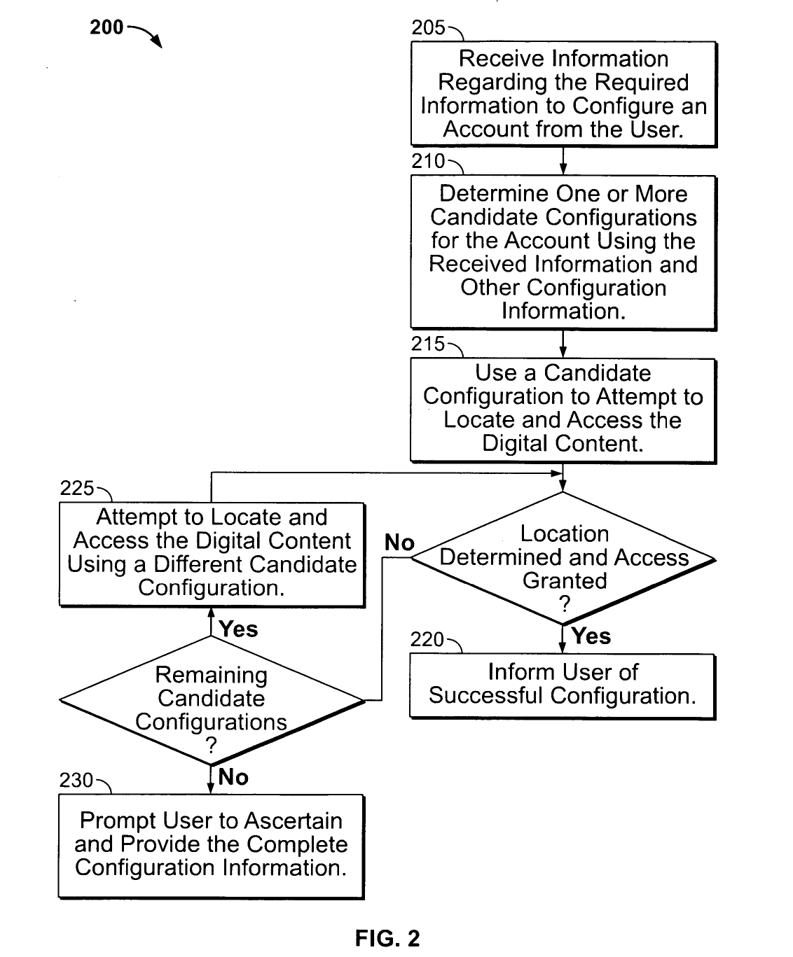

FIG. 2 illustrates a process in which a digital content communication system is configured to locate and access stored digital content in accordance with one embodiment of the present invention. Process 200, shown in FIG. 2, begins with operation 205 in which a portion of the information required to configure a system to locate and access stored digital content (e.g., stored e-mail messages in an external e-mail account) is received from a user. For one embodiment of the invention, the information provided by the user is provided via a mobile device. For one embodiment of the invention the information received from the user may be related to the actual information required to effect configuration, or may indicate aspects of the actual information required to effect configuration.

At operation 210 the application determines one or more candidate configurations for the account. In accordance with one embodiment of the invention the candidate configurations are determined using the information received from the user in conjunction with one or more rules that apply generally to the communication of digital content and define how a majority of accounts are configured. For example, the rules may define a precedence allowing for highly probable assumptions as to the location and access requirements of stored digital content.

In accordance with an alternative embodiment of the invention, one or more candidate configurations may be determined by correlating the information provided by the user with one or previously determined configurations.

At operation 215 one of the determined candidate configurations is selected and used to attempt to locate and access the digital content.

At operation 220, if the digital content is located and accessed using the configuration, the user is informed that the configuration has been successfully completed.

If the digital content cannot be located or accessed using the configuration, then another of the determined candidate configurations is selected and used to attempt to locate and access the digital content at operation 225.

If all of the determined candidate configurations have been used without successfully locating and accessing the digital content, then the user is prompted to ascertain and provide the complete configuration information at operation 230.

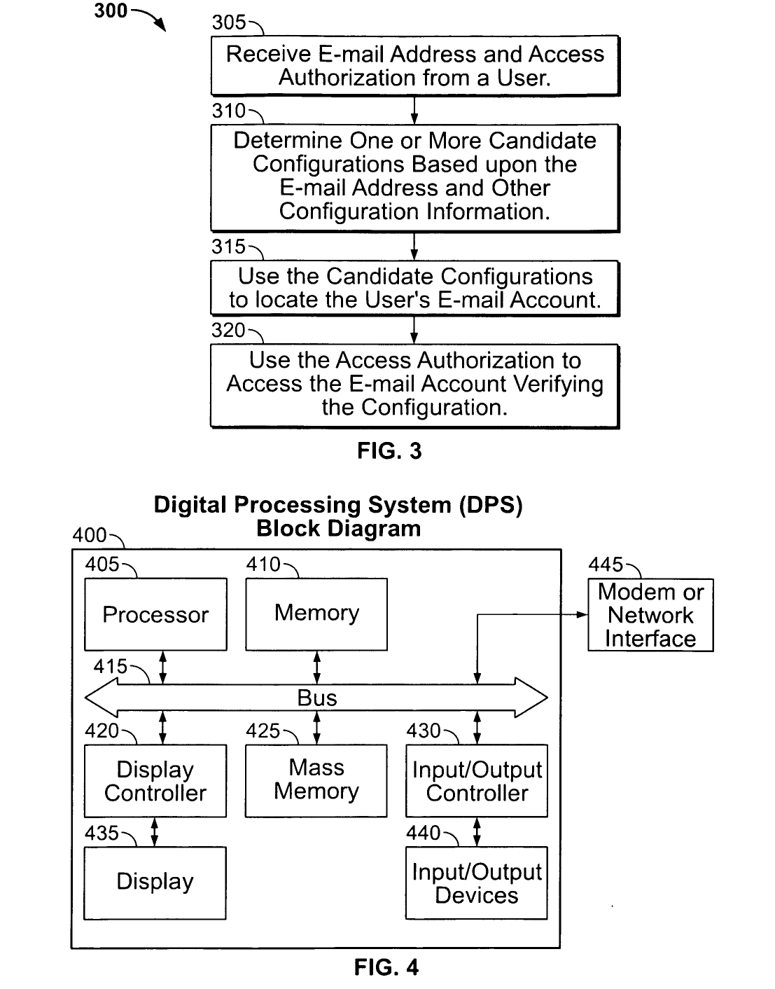

As discussed above, embodiments of the invention are applicable to a variety of digital content communication including e-mail message forwarding. FIG. 3 illustrates a process in which a DCC system is configured to access and forward e-mail messages from an external e-mail account in accordance with one embodiment of the invention. Process 300, shown in FIG. 3 begins at operation 305 in which an e-mail address (or portion of an e-mail address) and an access authorization password are received from a user. This is information that a user has typically committed to memory or has readily available.

At operation 310 various combinations of candidate configurations are determined based upon a set of rules and/or known configurations in conjunction with the information provided by the user. For example, if the user provides an e-mail address of “username@specificdomain.net” the mail server name may be related to the specific domain name provided. Assumptions as to probable mail server names are made, as are assumptions as to the transmission protocol and port information used to retrieve e-mail messages from a server. Using permutations of the combination of likely server names, protocols, and ports, a number of candidate configurations can be determined.

At operation 315 the various candidate configurations are used to attempt to locate and the user's e-mail account. So for the example discussed, where the domain name provided is “specific domain”, addresses such as specificdomain.net, mail.specificdomain.net, pop.specificdomain.net, and imap.specificdomain.net may be determined to be possible mail server names. Assumptions as to the possible transmission protocols and ports include POP and IMAP and 110 and 143, respectively. For one embodiment the candidate configurations may be designated as more or less probable. Attempts to locate the user's e-mail system would then be made with the more probable configurations first followed by the less probable configurations. For one embodiment, stored domain level configuration information is used first in an attempt to locate the user's e-mail system.

For one embodiment attempts to access the user's e-mail system may be made using a protocol for transmitting data securely over the Internet such as secure sockets layer (SSL) or secure-HTTP (SHTTP). For another embodiment of the invention attempts to access the user's e-mail system are made with and without a secure connection.

At operation 320 after determination of the correct server, protocol, and port information, an attempt is made to login to the e-mail system using the user's e-mail address and access authorization information (e.g., password). If the login attempt is successful (the user's e-mail is accessible), the particular configuration used is assumed to be the correct configuration for the user's e-mail system and is stored for the user. For one embodiment of the invention, the corresponding domain level configuration information is stored and can be used for other user's having common domain level information. For one such embodiment, multiple configurations may be stored for the same domain. For example, an ISP may have multiple e-mail servers with different configurations.

As discussed above, embodiments of the invention are applicable to various other types of digital content as well. For example, embodiments of the invention are applicable to published digital content such as web-syndicated content that is made generally available to specific groups or the general public. Such published content is typically stored in a general repository where it is located and accessed by a number of users. In accordance with one embodiment of the invention, a user may provide a generally used, or generally available name for such content and the DCC system will attempt to associate the name with configuration information.

As discussed above, embodiments of the invention may employ DPSs or devices having digital processing capabilities. FIG. 4 illustrates a functional block diagram of a digital processing system that may be used in accordance with one embodiment of the invention. The components of processing system 400, shown in FIG. 4 are exemplary in which one or more components may be omitted or added. For example, one or more memory devices may be utilized for processing system 400. Referring to FIG. 4, the processing system 400, shown in FIG. 4, may be used as a server processing system. Furthermore, the processing system 400 may be used to perform one or more functions of an Internet service provider. The processing system 400 may be interfaced to external systems through a network interface or modem 445. The network interface or modem may be considered a part of the processing system 400. The network interface or modem may be an analog modem, an ISDN modem, a cable modem, a token ring interface, a satellite transmission interface, a wireless interface, or other interface(s) for providing a data communication link between two or more processing systems. The processing system 400 includes a processor 405, which may represent one or more processors and may include one or more conventional types of processors, such as Motorola PowerPC processor or Intel Pentium processor, etc. A memory 410 is coupled to the processor 405 by a bus 415. The memory 410 may be a dynamic random access memory (DRAM) an/or may include static RAM (SRAM). The processor 405 may also be coupled to other types of storage areas/memories (e.g. cache, Flash memory, disk, etc.), that could be considered as part of the memory 410 or separate from the memory 410.

The bus 415 further couples the processor 405 to a display controller 420, a mass memory 425 (e.g. a hard disk or other storage which stores all or part of the application 145 and/or database 146, or stored digital content, depending on the DPS). The network interface or modem 445, and an input/output (I/O) controller 430. The mass memory 425 may represent a magnetic, optical, magneto-optical, tape, and/or other type of machine-readable medium/device for storing information. For example, the mass memory 425 may represent a hard disk, a read-only or writeable optical CD, etc. The display controller 420 controls, in a conventional manner, a display 435, which may represent a cathode ray tube (CRT) display, a liquid crystal display (LCD), a plasma display, or other type of display device. The I/O controller 430 controls I/O device(s) 440, which may include one or more keyboards, mouse/track ball or other pointing devices, magnetic and/or optical disk drives, printers, scanners, digital cameras, microphones, etc.

The processing system 400 represents only one example of a system, which may have many different configurations and architectures and which may be employed with the present invention. For example, various manufacturers provide systems having multiple busses, such as a peripheral bus, a dedicated cache bus, etc. On the other hand, a network computer, which may be used as a processing system of the present invention, may not include, for example, a hard disk or other mass storage device, but may receive routines and/or data from a network connection, such as the network interface or modem 445, to be processed by the processor 405. Similarly, a portable communication and data processing system, which may employ a cellular telephone and/or paging capabilities, may be considered a processing system that may be used with the present invention. However, such a system may not include one or more I/O devices, such as those described above with reference to I/O device 440.

In the system 400 shown in FIG. 4, the mass memory 425 (and/or the memory 410) may store data that may be processed according to the present invention. For example, the mass memory 425 may contain a database storing previously determined configuration information in accordance with one embodiment of the invention. Alternatively, data may be received by the processing system 400, for example, via the network interface or modem 445, and stored and/or presented by the display 435 and/or the I/O device(s) 440. In one embodiment, data may be transmitted across a data communication network, such as a LAN and/or the Internet.

General Matters

Embodiments of the invention include a system that ascertains configuration information for a digital content communication system to access digital content (e.g., an external e-mail account). For one embodiment of the invention, one or more possible configurations are determined using configuration information provided by the user in conjunction with known configuration parameters applicable to such systems.

Embodiments of the invention have been described as including various operations. Many of the processes are described in their most basic form, but operations can be added to or deleted from any of the processes without departing from the scope of the invention. For example, an embodiment of the invention is described, in reference to FIG. 2, in which one or more candidate configurations are determined and subsequently used to attempt to locate and access the stored digital content. In alternative embodiments of the invention, a candidate configuration may be determined and used to attempt to locate and access the stored digital content prior to determining other candidate configurations. For such an embodiment, a configuration deemed most likely may be used, which, if successful, eliminates the time and effort required to determine additional candidate configurations. Or, for example, an embodiment of the invention is described in reference to FIG. 2, in which various combinations of candidate configurations are determined based upon a set of rules and/or known configurations in conjunction with the information provided by the user. For alternative embodiments, attempts to locate the user's e-mail system are made using previously determined and verified configurations prior to determining candidate configurations.

The operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection). All operations may be performed at the same central cite or, alternatively, one or more operations may be performed elsewhere.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving a request from a user to configure a digital content communication system to communicate stored digital content, the request containing information related to a configuration to configure the digital content communication system to locate and access the stored digital content;
determining one or more candidate configurations based upon the related information; and
attempting to locate and access the stored digital content using one of the candidate configurations wherein if the stored digital content cannot be located and accessed using the candidate configuration, a successive attempt is made to locate and access the stored digital content using another of the candidate configurations.

2. The method of claim 1 further comprising:
upon locating and accessing the stored digital content, notifying the user of successful configuration.

3. The method of claim 1 wherein the related information is used in conjunction with known configuration parameters to determine the one or more candidate configurations.

4. The method of claim 1 wherein the related information is used in conjunction with stored configuration information to determine the one or more candidate configurations.

5. The method of claim 1, wherein the request from the user is received from a mobile communications device.

6. The method of claim 1, wherein in the stored digital content comprises e-mail messages of the user contained in one or more e-mail accounts.

7. The method of claim 1, wherein the stored digital content is digital content selected from the group consisting of e-mail messages, news feeds, blogs, audio content, video content, and combinations thereof.

8. The method of claim 1 further comprising:
assigning a corresponding probability of success to each candidate configuration; and
attempting to locate and access the stored digital content using a candidate configuration having a higher corresponding probability of success prior to attempting to locate and access the stored digital content using a candidate configuration having a lower corresponding probability of success.

9. The method of claim 1 further comprising:
upon having attempted to locate and access the stored digital content using each of the one of the candidate configurations successively, notifying the user that attempted configuration was unsuccessful.

10. The method of claim 9 further comprising:
prompting the user to provide complete configuration information.

11. The method of claim 2 further comprising:
communicating the stored digital content as directed by the user.

12. The method of claim 11 wherein communicating the stored digital content as directed by the user includes forwarding the stored digital content to a mobile device.

13. A machine-readable medium that provides executable instructions, which when executed by a processor, cause the processor to perform a method, the method comprising:
receiving a request from a user to configure a digital content communication system to communicate stored digital content, the request containing information related to a configuration to configure the digital content communication system to locate and access the stored digital content;
determining one or more candidate configurations based upon the related information; and
attempting to locate and access the stored digital content using one of the candidate configurations wherein if the stored digital content cannot be located and accessed using the candidate configuration, a successive attempt is made to locate and access the stored digital content using another of the candidate configurations.

14. The machine-readable medium of claim 13 wherein the method further comprises:
upon locating and accessing the stored digital content, notifying the user of successful configuration.

15. The machine-readable medium of claim 13 wherein the related information is used in conjunction with known configuration parameters to determine the one or more candidate configurations.

16. The machine-readable medium of claim 13 wherein the related information is used in conjunction with stored configuration information to determine the one or more candidate configurations.

17. The machine-readable medium of claim 13 wherein the request from the user is received from a mobile communications device.

18. The machine-readable medium of claim 13 wherein in the stored digital content comprises e-mail messages of the user contained in one or more e-mail accounts.

19. The machine-readable medium of claim 13 wherein the stored digital content is digital content selected from the group consisting of e-mail messages, news feeds, blogs, audio content, video content, and combinations thereof.

20. The machine-readable medium of claim 13 wherein the method further comprises:
assigning a corresponding probability of success to each candidate configuration; and
attempting to locate and access the stored digital content using a candidate configuration having a higher corresponding probability of success prior to attempting to locate and access the stored digital content using a candidate configuration having a lower corresponding probability of success.

21. The machine-readable medium of claim 13 wherein the method further comprises:
upon having attempted to locate and access the stored digital content using each of the one of the candidate configurations successively, notifying the user that attempted configuration was unsuccessful.

22. The machine-readable medium of claim 21 wherein the method further comprises:
prompting the user to provide complete configuration information.

23. The machine-readable medium of claim 14 wherein the method further comprises:
communicating the stored digital content as directed by the user.

24. The machine-readable medium of claim 23 wherein communicating the stored digital content as directed by the user includes forwarding the stored digital content to a mobile device.

25. A system comprising:
one or more digital content storage devices storing digital content;
one or more communication devices capable of receiving and presenting digital content; and
a digital content communication device coupling at least one of the digital content storage devices to at least one of the communication devices;
a configuration application, stored on the digital content communication device, to receive a request from a user, the request containing information related to a configuration to configure the digital content communication device to locate and access the stored digital content, determine one or more candidate configurations based upon the related information, and attempt to locate and access the stored digital content using one of the candidate configurations wherein if the stored digital content cannot be located and accessed using the candidate configuration, a successive attempt is made to locate and access the stored digital content using another of the candidate configurations.

26. The system of claim 25 wherein the configuration application further notifies the user of successful configuration upon locating and accessing the stored digital content.

27. The system of claim 25 wherein the one or more candidate configurations are determined using the related information in conjunction with known configuration parameters.

28. The system of claim 27 further comprising:
a domain name system server coupled to the digital content communication system, the domain name system server storing a database of digital content host systems and a corresponding Internet Protocol address for each digital content host system, the configuration application accessing the database to verify domain names of the candidate configurations.

29. The system of claim 25 wherein the request from the user is received from a mobile communications device.

30. The system of claim 25 wherein in the stored digital content comprises e-mail messages of the user contained in one or more e-mail accounts.

31. The system of claim 25 wherein the stored digital content is digital content selected from the group consisting of e-mail messages, news feeds, blogs, audio content, video content, and combinations thereof.

32. The system of claim 25 wherein the application further assigns a corresponding probability of success to each candidate configuration and attempts to locate and access the stored digital content using a candidate configuration having a higher corresponding probability of success prior to attempting to locate and access the stored digital content using a candidate configuration having a lower corresponding probability of success.

33. The system of claim 26 wherein the digital content communication device communicates the stored digital content as directed by the user.

34. The system of claim 33 wherein communicating the stored digital content as directed by the user includes forwarding the stored digital content to a mobile device.
